(19) United States
(12) Patent Application Publication
(10) Pub. No.: US 2010/0202512 A1
(43) Pub. Date: Aug. 12, 2010

(54) COLOR VIDEO SCALABILITY ENCODING AND DECODING METHOD AND DEVICE THEREOF

(76) Inventors: Hae-Chul Choi, Daejon (KR); Jie Jia, Seoul (KR); Hae-Kwang Kim, Seoul (KR); Jeong-Ju Yoo, Daejon (KR)

Correspondence Address: LADAS & PARRY LLP, 224 SOUTH MICHIGAN AVENUE, SUITE 1600, CHICAGO, IL, 60604, US

(21) Appl. No.: 12/595,987

(22) PCT Filed: Apr. 16, 2008
(86) PCT No.: PCT/KR08/02144

§ 371 Date: Apr. 14, 2010

Related U.S. Application Data
(60) Provisional application No. 60/911,987, filed on Apr. 16, 2007.

(51) Int. Cl. H04N 7/26; H04N 7/30

(52) U.S. Cl. 375/240.03; 375/240.24; 375/E07.126; 375/E07.226

(57) ABSTRACT

Provided are a color video scalability encoding and decoding method and a device thereof. The color video scalability encoding method includes encoding a chrominance image block of an enhancement layer by using lower layer information. In the encoding a chrominance image block, a color coded block pattern value is generated according to a pattern of quantization coefficients of a residual chrominance Image block chrominance image block generated using the lower layer information.

### TECHNICAL FIELD

The present invention relates to a color video scalability encoding and decoding method and a device thereof; and, more particularly, to a color video scalability encoding and decoding method for encoding and decoding scalability of a color format of a video and a device thereof.

This work was supported by the IT R&D program of MIC/IITA [2005-S-103-02, “Development of Ubiquitous Content Access Technology for Convergence of Broadcasting and Communications”].

### BACKGROUND ART

When video is encoded, a color format of the video is indicated by a ratio of luminance and chrominance of pixels in a horizontal pixel line of a picture that forms the video. The color format may be also referred as a chroma format. In general, ‘Y’ denotes luminance, and ‘Cb’ and ‘Cr’ represent chrominance. The luminance is a degree of brightness of an image. Luminance of a pixel is indicated as an 8-bit value according to ITU-R advice. A color coordinates system is referred as a color space. In MPEG that is the standard of video encoding indicates a color format of video as three 8-bit informations Y, Cb, and Cr.

A video can be expressed in various color formats according to a ratio of Y, Cb, and Cr. Although color formats are different from each others, Y components thereof are the same. However, the Y components are encoded again when the video is encoded in different color formats. Therefore, the encoding method according to the related art is not efficient.

In video encoding technologies introduced by international standard organizations such as MPEG-2, MPEG-4, and Joint Video Team (JVT), Y component is repeatedly encoded when a video is encoded in color formats of 4:4:4, 4:2:2, and 4:2:0. The repetition of encoding information that was already encoded may unnecessarily increase the amount of data when a video is encoded in various color formats, stored, and transmitted.

FIG. 1 illustrates color formats generally used in video compression. In video compression according to the related art, lossy compression is performed by decreasing a color spatial resolution because a visual sense of human is less sensitive to color information than brightness information.

If a chrominance image in a color format of 4:4:4 has an N×N pixel size, a luminance image Y and chrominance images Cr and Cb have the same N×N pixel size. Since there are pixels of the Cr and Cb images corresponding to each pixel of the luminance image, an image format has high quality color information.

An image in a format of 4:2:2 is obtained by only down-sampling the chrominance images Cr and Cb in a horizontal direction without down-sampling the chrominance images Cr and Cb in a vertical direction. If the chrominance images Cr and Cb of the format of 4:4:4 have an N×N pixel size, the down-sampled chrominance images Cr and Cb have an N×(N/2) pixel size.

An image of a 4:2:0 format is an image obtained by down-sampling the chrominance images Cr and Cb in the format of 4:4:4 in both of the vertical direction and the horizontal direction. If the chrominance images Cr and Cb have an N×N pixel size, the down sampled chrominance images Cr and Cb have a (N/2)×(N/2) pixel size.

FIG. 2 is a block diagram illustrating a color video encoding device according to the related art.

As shown in FIG. 2, if an image formed of original Y, Cr, and Cb images in a format of 4:4:4 is inputted, the video encoding device according to the related art outputs a bitstream encoded in a format of 4:4:4. If an image formed of original Y, Cr, and Cb images in a format of 4:2:2 is inputted, the video encoding device according to the related art outputs a bitstream encoded in a format of 4:2:2. If an image formed of original Y, Cr, and Cb images in a format of 4:2:0 is inputted, the video encoding device according to the related art outputs a bitstream encoded in a format of 4:2:0.

The video encoding device includes a Y component encoder 210, a Cr and Cb component encoder 220, and a MUX 230 for multiplexing. Although the Cr and Cb components inputted to the Cr and Cb component encoder 320 are different according to a color format of an inputted image, the Y component is the same. This is because Y components in image formats of 4:4:4, 4:2:2, and 4:2:0 of are the same as shown in FIG. 1. The Y component encoder 210 compensates motions of an image by estimating a motion vector from the inputted Y signal, obtains Y components of texture information by performing Discrete Cosine Transform (DCT), Quantization, and Entropy Coding on the compensated images, and outputs the obtained Y components. The Cr and Cb component encoder 220 obtains Cb and Cr components of texture information by compensating motions of an image based on a motion vector of an Y signal and outputs the obtained Cb and Cr components. The MUX unit 230 generates a video encoded bitstream in one of formats of 4:4:4, 4:2:2, and 4:2:0 by multiplexing the motion vector, the Y component of texture information, and the Cr and Cb components of texture information, and outputs the generated video encoded bitstream.

Hereinafter, the operations of the Y component encoder 210 will be described in detail. A motion estimator 210 finds a motion estimation value of a macro block of a current frame from a reference frame and outputs the motion difference thereof as a motion vector. That is, the most similar macro block is found by searching a target macro block in a predetermined searching area of a reference frame, and a degree of movements thereof is outputted as a motion vector. The motion compensator 202 obtains an estimated macro block corresponding to the motion vector from a reference frame.

The estimated macro block of the reference image frame is subtracted from a macro block of an original frame, and a DCT unit 230 performs DCT on the difference thereof. A quantizer 204 quantizes the DCT coefficient thereof and an entropy encoder 205 encodes the quantized DCT coefficient, thereby outputting texture information. A multiplexer 230 multiplexes the texture information without motion vector and outputs an encoded bitstream.

Residual is the subtraction of the macro block of an original image frame and a macro block of the motion compensated reference image frame. The residual is encoded in order to reduce a data amount. Since error is generated in a quantization process, video data made of the bitstream includes error generated from the DCT process and the quantization process. In order to obtain a reference image, the quantized residual signal is combined with a motion estimated and compensated image from a dequantizer 206 and an Inverse Discrete Cosine Transform (IDCT) unit 207 and stored in a decoded Y image 208. Therefore, the reference image stored in the decoded Y image 208 becomes an original image with a coded error generated in the DCT process and the quantization process. The Or and Cb components encoder 220 encodes chrominance components Or and Cb similar to the Y component encoder 210.

If one original video is encoded in formats of 4:4:4, 4:2:2, and 4:2:0, the Cr and Cb component encoder 220 receives Cb/Cr component in the formats of 4:4:4, 4:2:2, and 4:2:0, encodes the Cb/Cr components, and multiplexes the encoded Cb/Cr components with the Y components. As described above, the encoding method according to the related art have a disadvantage of repeatedly encoding the Y components.

### DISCLOSURE

### Technical Problem

An embodiment of the present invention is directed to improvement of encoding efficiency by preventing a data amount from being unnecessarily increased when encoded information is stored and transmitted by not repeatedly encoding information identical to information on a previously encoded layer if the information on a previously encoded layer is provided.

Another embodiment of the present invention is directed to improvement of decoding efficiency by not repeatedly decoding information identical to information on a previously decoded layer when information on the previously decoded layer is provided.

Still another embodiment of the present invention is directed to a color format scalability encoding and decoding device and a method thereof for effectively encoding and decoding only a color component of an enhancement layer with a spatial scalability function, a temporal scalability function, and a quality scalability function in a video compression technology.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a color video scalability encoding method, including: encoding a color image block of an enhancement layer by using lower layer information, wherein in the said encoding a color image block, a color coded block pattern value is generated according to a pattern of quantization coefficients of a residual chrominance image block generated using the lower layer information.

In accordance with another aspect of the present invention, there is provided a color video scalability encoding apparatus including: an encoder for encoding a color image block of an enhancement layer by using lower layer information; and a transmitter for transmitting the encoded color image block, wherein the encoder generates a color coded block pattern value according to a pattern of quantization coefficients of a residual chrominance image block generated using the lower layer information.

In accordance with another aspect of the present invention, there is provided a color video scalability decoding method, including: determining whether a received bitstream includes an enhancement layer having a color format different from a color format of a lower layer; and decoding a color image block of the enhancement layer by using lower layer information of the lower layer.

In accordance with another aspect of the present invention, there is provided a color video scalability decoding apparatus including: a receiver for receiving a bitstream; and a decoder for determining whether the received bitstream includes an enhancement layer having a color format different from a color format of a lower layer and decoding a color image block of the enhancement layer by using lower layer information of the lower layer.

In accordance with another aspect of the present invention, there is provided a color video scalability decoding method including: decoding a color image block of an enhancement layer by using lower layer information included in a received bitstream, wherein in said decoding a color image block, determining decoding is performed or not according to a color coded block pattern value generated using the lower layer information.

In accordance with another aspect of the present invention, there is provided a color video scalability decoding apparatus including: a receiver for receiving a bitstream; and a decoder for encoding a color image block of an enhancement layer by using lower layer information included in the received bitstream, wherein the decoder determines whether decoding is performed according to a color coded block pattern value generated using the lower layer information.

In accordance with another aspect of the present invention, there is provided a computer-readable recording medium storing a program for performing a color video scalability encoding method including: encoding a color image block of an enhancement layer by using lower layer information, wherein in the said encoding a color image block, a color coded block pattern value is generated according to a pattern of quantization coefficients of a residual chrominance block generated using the lower layer information.

In accordance with another aspect of the present invention, there is provided a computer-readable recording medium storing a program for performing a color video scalability decoding method including: determining whether a received bitstream includes an enhancement layer having a color format different from a color format of a lower layer; and decoding a color image block of the enhancement layer by using lower layer information of the lower layer.

In accordance with another aspect of the present invention, there is a computer-readable recording medium storing a program for performing a color video scalability decoding method including: decoding a color image block of an enhancement layer by using lower layer information included in a received bitstream, wherein in said decoding a color image block, determining decoding is performed or not according to a color coded block pattern value generated using the lower layer information.

The advantages, features and aspects of the invention will become apparent from the following description of the embodiments with reference to the accompanying drawings, which is set forth hereinafter. Therefore, those skilled in the art may easily embody technical aspects of the invention. When it is considered that detailed description on a related art may obscure a point of the present invention, the description will not be provided herein. Hereinafter, specific embodiments of the present invention will be described in detail with reference to the accompanying drawings.

### ADVANTAGEOUS EFFECTS

According to the present invention, a data amount is prevented from being unnecessarily increased when encoded information is stored and transmitted by not repeatedly encoding information identical to information on a previously encoded layer if the information on a previously encoded layer is provided. Therefore, the data encoding efficiency is improved.

Decoding efficiency is improved by not repeatedly decoding information identical to information on a previously decoded layer when information on the previously decoded layer is provided.

A color format scalability encoding and decoding device and a method thereof can be provided for effectively encoding and decoding only a color component of an enhancement layer with a spatial scalability function, a temporal scalability function, and a quality scalability function in a video compression technology.

### BRIEF DESCRIPTION OF THE DRAWINGS

FIG. 1 illustrates color formats generally used in video compression.

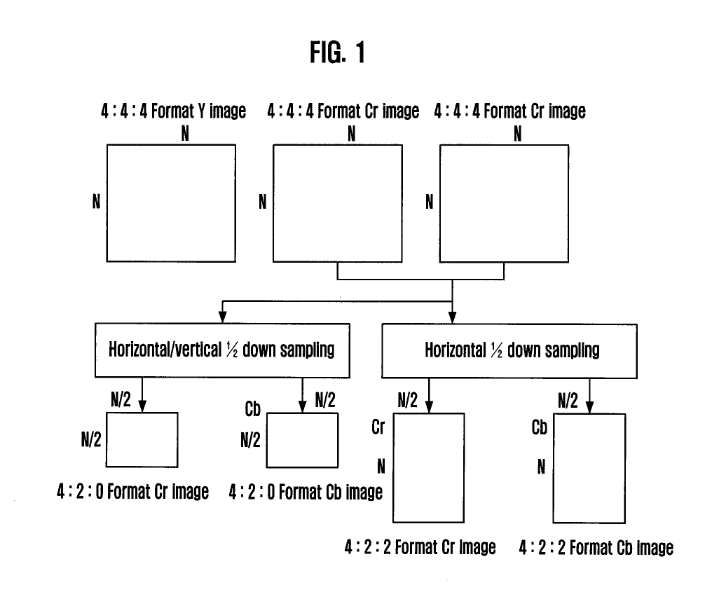

FIG. 2 is a block diagram illustrating a color video encoding device according to the related art.

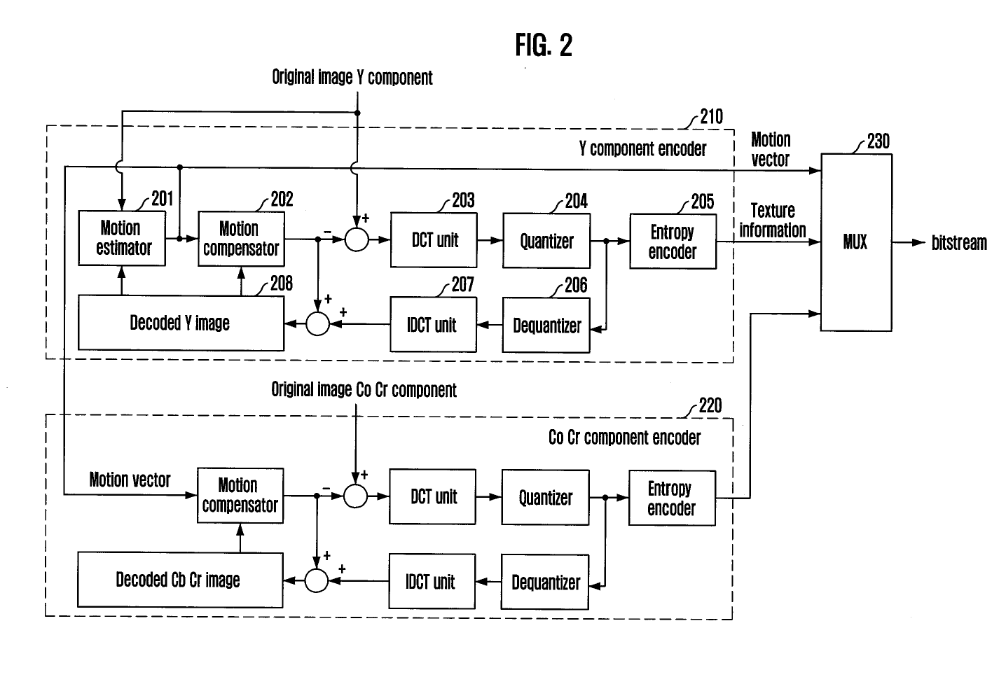

FIG. 3 is a flowchart describing a color video scalability encoding method in accordance with an embodiment of the present invention.

FIG. 4 is a block diagram illustrating a color video scalability encoding method in accordance with an embodiment of the present invention.

FIG. 5 is a flowchart illustrating a color video scalability decoding method in accordance with an embodiment of the present invention.

FIG. 6 is a block diagram illustrating a color video scalability decoding method in accordance with an embodiment of the present invention.

### BEST MODE FOR THE INVENTION

The following not restricts but illustrates fundamentals of the invention. Those skilled in the art may embody the fundamentals of the invention and invent various apparatuses without departing from concepts and scope of the invention, although the invention is not clearly described or illustrated in the specification. Conditional terms and embodiments in the specification are only intended to clearly describe concepts of the invention, and they should be understood to limit the scope of the invention.

Also, it should be understood that all of descriptions of fundamentals, aspects, embodiments of the invention, and a certain embodiment are intended to include structural and functional equivalents thereof. Furthermore, it should be understood that such equivalents include not only well-known equivalents but also equivalents to be invented to perform the same function regardless of their structures.

Therefore, it should be understood that a block diagram of the specification shows conceptual aspects of an exemplary circuit for embodying fundamentals of the invention. Similarly, all flowcharts, state transition diagrams, pseudo codes may substantially represent computer-readable media, and various processes performed by a computer or a processor although the computer or the processor is not apparently illustrated.

Functions of various devices shown in a drawing including functional blocks shown as processors or similar concepts may be provided not only using dedicated hardware but also using hardware capable of performing predetermined software. When the functions are provided by a processor, the functions may be provided by a single dedicated processor, a single shared processor, or a plurality of individual processors. Among them, some may be shared.

Terms used for a processor, control, or similar concepts may not be understood by exclusively citing hardware capable of performing software, and may be understood to suggestively include a digital signal processor (DSP) hardware, a read only memory (ROM), a random access memory (RAM), and nonvolatile memory for storing software without limitation.

In claims, constituent elements expressed as means for performing functions described in the specification are intended to include combination of circuit devices for performing the functions and all methods performing the functions including all types of software having firmware/micro codes. Also, the constituent elements are connected to a proper circuit for performing the software to perform the functions. Any means providing the functions should be understood as equivalent to those understood from the specification because the invention defined by the claims is combined with functions provided by the various described means and combined with methods required by the claims.

The advantages, features and aspects of the invention will become apparent from the following description of the embodiments with reference to the accompanying drawings, which is set forth hereinafter. Therefore, those skilled in the art may easily embody technical aspects of the invention. When it is considered that detailed description on a related art may obscure a point of the present invention, the description will not be provided herein. Hereinafter, specific embodiments of the present invention will be described in detail with reference to the accompanying drawings.

Within a range of clearly describing functions and operations of each constituent elements of a color video scalability encoding and decoding and a method thereof according to the present invention, Joint Video Team (JVT) ISO/IEC standard documents of International Organization for Standardization (ISO)/International Electro-technical Commission (IEC) (MPEG & ITU-T VCEG) may be included in the specification as a part.

The present invention encodes or decodes information of the other layers according to information previously encoded or decoded layers not to repeatedly encode or decode information on the previously encoded or decoded layers when the information on the previously encoded or decoded layers are provided. The previously encoded or decoded layer may have a color format different from a color format of a layer to be encoded or decoded. The color format may be formats of 4:4:4, 4:2:2, and 4:0:0.

Streams are arranged in various layers by scalability video coding (SVC). A scalability encoding based decoder can selectively decode a predetermined part of an encoded bitstream. Layers include a lower layer and an enhancement layer. The lower layer and the enhancement layer have a relative concept. The lower layer may be a layer below a currently pointed layer, and the enhancement layer may be a layer above the currently pointed layer. Maybe two or more of lower layers and enhancement layers are present. For example, a base layer may be included in the lower layer. The enhancement layer may be a first enhancement layer, a second enhancement layer, and a third enhancement layer. The scalability video coding may include spatial scalability, temporal scalability, or quality scalability. The spatial scalability generates a base layer by sub-sampling a video frame or a video object in a horizontal direction or a vertical direction and generates an enhancement layer by using a difference between an estimated frame and a frame of an original resolution, thereby coding it as a layer of a spatial resolution. The temporal scalability provides a low frame rate of a base layer and an enhancement layer for a high frame rate. The quality scalability provides an enhancement layer for improving a visual quality.

Therefore, the present invention relates to an encoding and decoding method for encoding or decoding an enhancement layer by using repeated lower layer information when more than two layers (enhancement layer and lower layer) have different color formats and repeated information is included in different color formats similar to the scalability encoding and decoding. The present invention also relates to an encoding and decoding method that encodes and decodes an enhancement layer by adding color information to image information of an encoded or decoded lower layer. Luminance information or chrominance information of the lower layer or chrominance information of an enhancement layer are exemplary described in luminance (Y component) and chrominance information (Cr and Cb components) in different color formats (4:4:4, 4:2:2, 4:0:0)

### 1^{st} Embodiment: Color Video Scalability Encoding Method

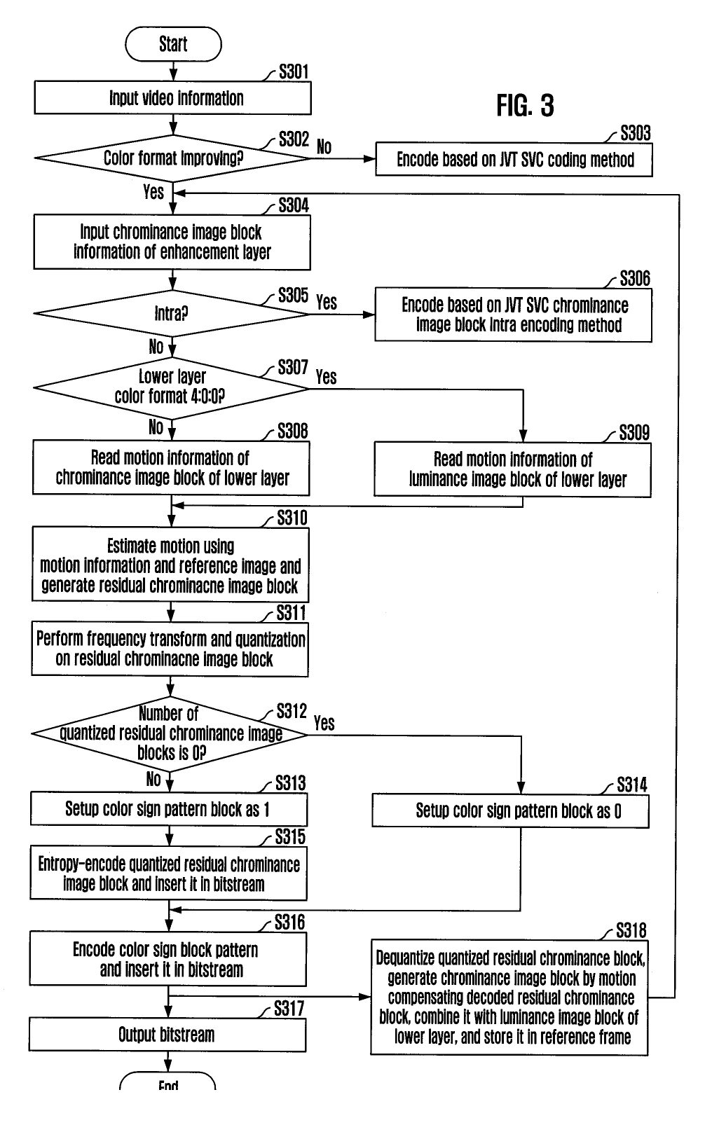

FIG. 3 is a flowchart describing a color video scalability encoding method in accordance with an embodiment of the present invention.

The color video scalability encoding method according to the present embodiment includes a coding step for encoding chrominance image blocks of an enhancement layer by using lower layer information. The coding step includes generating a color block pattern value according to a pattern of quantization coefficients of a residual chrominance block generated using the lower layer information, and determining whether or not an encoding operation is performed according to the color coded block pattern value. In this way, it is possible to prevent repeatedly encoding a lower layer and an enhancement layer. Here, the color video scalability encoding method according to the present embodiment further includes determining whether a color format of the enhancement layer is different from that of a lower layer or not.

The lower layer information may be motion information of a luminance image block of a lower layer. If the lower layer information is motion information of a luminance image block of a lower layer, the coding step may include generating a residual chrominance image block using the motion information of a luminance image block and a reference image, quantizing the residual chrominance image blocks, setting up a color coded block pattern to ‘0’ if all coefficients of the quantized color residual chrominance image blocks are ‘0’, performing entropy coding the quantized residual chrominance image block if all coefficients of the quantized residual chrominance image blocks are not ‘0’, and outputting encoding information of the color coded block pattern and the encoded residual chrominance image block as a bitstream.

The lower layer information may be motion information of a chrominance image block of a lower layer. If the lower layer information is the motion information of a chrominance image block of a lower layer, the encoding step may include generating a residual chrominance image block using motion information of a chrominance image block and a reference image, quantizing the residual chrominance image block, setting up a color coded block pattern to ‘0’ if all coefficients of the quantized residual chrominance image block are ‘0’, entropy encoding the quantized residual chrominance image block if all coefficients of the quantized residual chrominance image block are not ‘0’, and outputting encoding information of a color coded block pattern and information of the encoded residual chrominance image block.

Hereinafter, a color video scalability encoding method in accordance with an embodiment of the present invention will be described with reference to a drawing.

When video information is inputted at step S301, it is determined whether the video information includes an enhancement layer having a color format different from that of a lower layer or not at step S302. If the color format of the lower layer is 4:0:0 and the color format of the enhancement layer is 4:2:0, the color formats are different from each other. If the color format of the lower layer is identical to the color format of the enhancement layer, the video information is encoded using a typical JVT SVC encoding method at step S303.

If the color format of the lower layer is different from the color format of the enhancement layer, chrominance image block information of the enhancement layer is received at step S304. It is determined whether the chrominance image block information of the enhancement layer is intra-encoded or not at step S305. If it is determined to use the intra encoding, the video information is encoded using a JVT SVC chrominance image block intra encoding method at step S306. If it is determined not to use the intra encoding, Inter coding is performed. The intra coding is a method of encoding without motion compensation, and the Inter coding is a method of encoding with motion compensation. Hereinafter, the present embodiment will be described as the Inter encoding is performed.

At step S307, it is determined whether a color format of the lower layer is 4:0:0 or not. It is performed to decide whether information of a chrominance image block of a lower layer is used or information of a luminance image block is used in the lower layer. If the color format of the lower layer is 4:0:0, information of an image block only include brightness information or brightness information (Y components). If the color format of the lower layer is one of 4:2:0, 4:2:2, and 4:4:4, information of an image block include color information such as Cr and Cb.

If the color format of the lower layer is 4:0:0, motion information of the luminance image block of the lower layer is read at step S309. If the color format of the lower is not 4:0:0, the motion information of the chrominance image block of the lower layer is read at step S308. Here, the motion information includes information of a motion vector.

Then, the motion is estimated using the motion information and a reference image, and a residual chrominance image block is generated at step s310. The reference image may be a reference image of an enhancement layer or a reference image of a lower layer. The residual chrominance image is frequency-transformed and quantized at step s311.

At step S312, it is determined whether all coefficients of the quantized residual chrominance image block are ‘0’ or not. If the all coefficients of the quantized residual chrominance image block are ‘0’, a color coded block pattern is setup to ‘0’ at step S314.

If any one of the coefficients of the quantized residual chrominance image block is not ‘0’, the color coded block pattern is setup to ‘1’ at step S313. Here, the color coded block pattern is setup to ‘0’ or ‘1’ in order to identify a block having ‘0’s for all coefficients of the quantized residual chrominance image block. Therefore, the value of the color coded block pattern may be changed.

If the color code pattern is setup to ‘1’, the quantized residual chrominance image block is encoded using an entropy encoding scheme and the encoded residual chrominance image block is inserted into a bitstream at step S315. Also, the color coded block pattern is encoded and inserted into the bitstream at step S316.

The information of the encoded residual chrominance image block and the color block pattern is include into the bitstream and the bitstream is outputted at step S317.

Meanwhile, the above described procedure may include dequantizing the quantized residual chrominance image block, generating a chrominance image block by compensating motions of a decoded residual chrominance image block using a reference image, combining the chrominance image block with a luminance image block of a lower layer, and storing it in a reference frame.

### 2^{nd} Embodiment: Color Video Scalability Encoding Device

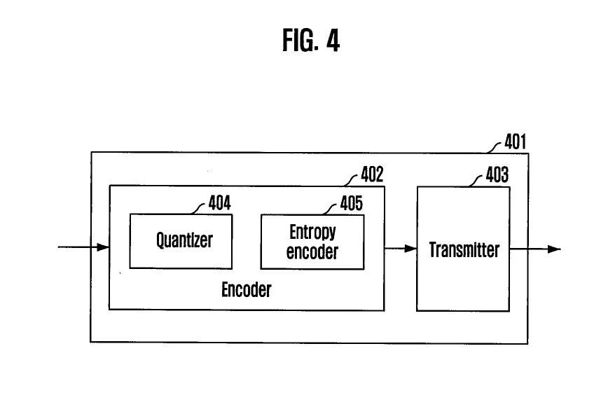

FIG. 4 is a block diagram illustrating a color video scalability encoding device in accordance with an embodiment of the present invention.

Referring to FIG. 4, the color video scalability encoding device 401 includes an encoder 402 for encoding a chrominance image block of an enhancement layer by using information of a lower layer, a transmitter 403 for transmitting the encoded chrominance image block. The encoder 402 generates a color block pattern value according to a pattern of quantization coefficients of residual chrominance image blocks generated using the information of the lower layer, and decides whether an encoding process is performed using the color coded block pattern value or not. Therefore, it is possible to prevent the lower layer and the enhancement layer from being encoded repeatedly. Here, the encoder 402 determines whether a color format of the enhancement layer is different from a color format of the lower layer.

The lower layer information may be motion information of a luminance image block of the lower layer. If the lower layer information is the motion information of the rightness image block of the lower layer, the encoder 402 includes an quantizer 404 for generating a residual chrominance image block using the motion information of the luminance image block and the reference image and quantizing the residual chrominance image block, and an entropy encoder 305 for setting up the color coded block pattern to ‘0’ if all of coefficients of the quantized residual chrominance image block are not ‘0’ and performing an entropy encoding on the quantized residual chrominance image block if the all coefficients of the quantized residual chrominance image blocks are ‘0’. An output unit 403 outputs the information of encoding the color coded block pattern and the information of the encoded residual chrominance image block as a bitstream.

The lower layer information may be motion information of a chrominance image block of the lower layer. The lower layer information is the motion information of the luminance image block of the lower layer, the encoder 402 includes a quantizer 404 for generating a residual chrominance image block using motion information of a chrominance image block and a reference image and quantizing a residual chrominance image block, and an entropy encoder 405 for setting up a color block pattern to ‘0’ if all of the coefficients of the quantized residual chrominance image block are ‘0’ and performing an entropy encoding operation on the quantized residual chrominance image block if all of the coefficients of the quantized residual chrominance image block are not ‘0’. The output unit 403 outputs encoding information of the color block pattern and information on the encoded residual chrominance image block as a bitstream.

Since the operations of the encoder 402 and the transmitter 403 of the color video scalability encoding device 401 are already described in the color video scalability encoding method according to the first embodiment, the detailed description thereof is omitted.

### 3^{rd} Embodiment: Color Video Scalability Decoding Method

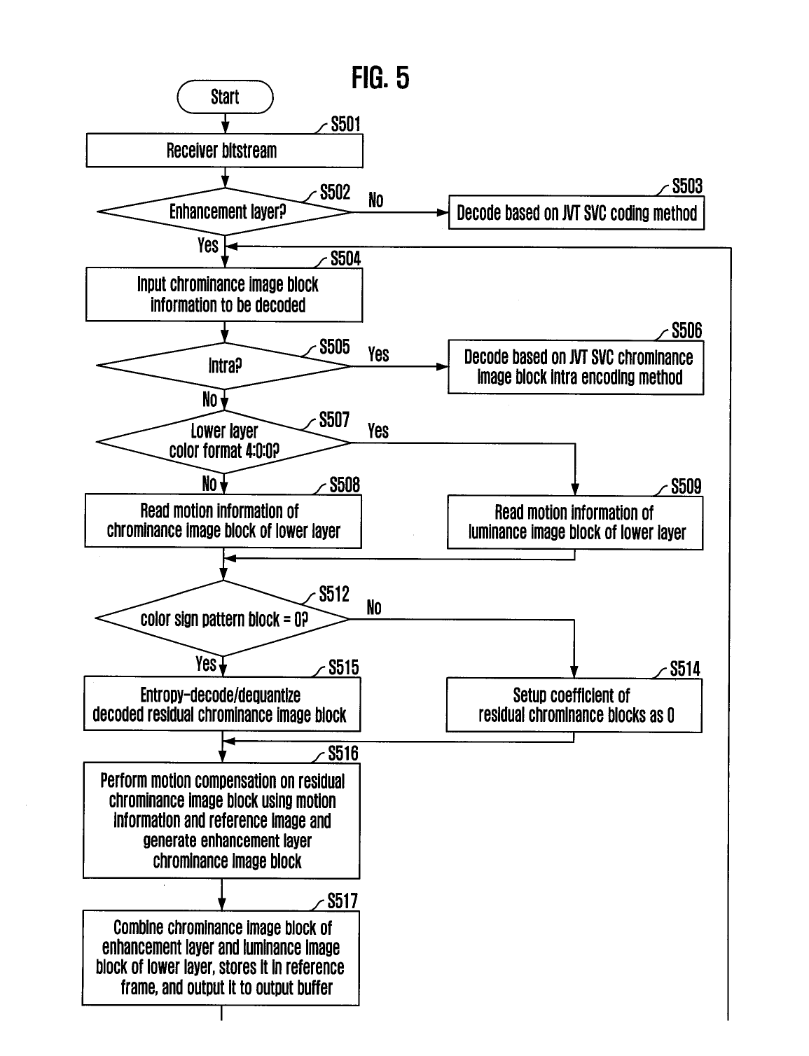

FIG. 5 is a flowchart illustrating a color video scalability decoding method in accordance with an embodiment of the present invention.

The color video scalability decoding method according to the predetermined embodiment includes determining whether a received bitstream includes an enhancement layer having a color format different from a color format of a lower layer, and decoding a color image block of the enhancement layer by using lower layer information of the lower layer.

The lower layer information may be motion information of a brightness image block of the lower layer. The decoding step may include generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, generating a color image block of the enhancement layer by compensating motion of the residual chrominance image block using the motion information and a reference image; and combining a color image block of the enhancement layer and a brightness image block of the lower layer.

The lower layer information may be motion information of a color image block of the lower layer. The decoding step may include generating a residual chrominance color image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, generating a color image block of the enhancement layer by compensating motion of the residual chrominance image block using the motion information and a reference image, and combining a color image block of the enhancement layer and a brightness image block of the lower layer. Hereinafter, the color video scalability decoding method according to the present embodiment will be described in detail.

Referring to FIG. 5, an encoded bitstream is received at step S501. It is determined whether or not the encoded bitstream includes an enhancement layer having a color format different from a color format of a lower layer at step S502. If the color format of the lower layer is 4:0:0 and the color format of the enhancement layer is 4:2:0, it is determined the color formats of the lower layer and the enhancement layer are different. If the color formats of the lower layer and the enhancement layer are the same, the encoded bitstream is decoded using a typical JVT SVC decoding method at step S503.

If the color formats of the lower layer and the enhancement layer are different, chrominance image block information of the enhancement layer is received at step S504. Then, it is determined whether intra decoding is performed for decoding the chrominance image block information of the enhancement layer or not at step S505. If it is determined that the intra decoding is performed for decoding the chrominance image block information of the enhancement layer, a JVT SVC chrominance image block intra decoding scheme is used at step S506. If the chrominance image block information is encoded by intra coding, an intra decoding scheme may be used to decode. If it is determined that the intra decoding is not performed, an Inter decoding may be performed. The intra decoding is a method of decoding without motion compensation, and the Inter decoding is a method of decoding using motion estimation based on motion compensation. Hereinafter, the present embodiment is described as using the Inter decoding.

At step S507, it is determined whether the color format of the lower layer is 4:0:0 or not. This is to determine whether information to be used in the lower layer is the chrominance image block information or bright image block information. If the color format of the lower layer is 4:0:0, the image block information includes only brightness or luminance information (Y components). If the color format of the lower layer is one of 4:2:0, 4:2:2, and 4:4:4, the image block information include color information (Cr and Cb).

If the color format of the lower layer is 4:0:0, motion information of a luminance image block of the lower layer is read at step S509. If the color format of the lower layer is not 4:0:0, the motion information of a chrominance image block of a lower layer is read at step S508. Here, the motion information includes information of a motion vector.

Then, a value of a color coded block pattern is determined at step s510. Since values of the color block pattern were exemplary described as one of ‘1’ and ‘0’ in the first embodiment, the color video scalability decoding method according to the present embodiment is described based on the described values of the color coded block pattern. If the value of the color coded block pattern is ‘0’, all of the coefficients of the residual chrominance image block are setup to ‘0’ at step S512. If the value of the color coded block pattern is not ‘0’, the encoded residual chrominance image block included in the bitstream is processed through entropy decoding, inverse quantization, and inverse frequency transform at step S511. Then, the inverse-transformed residual chrominance image block is motion compensated using the motion information and the reference image, and a chrominance image block of the enhancement layer is generated at step S513. Here, the reference image may be a reference image of the enhancement layer or a reference image of the lower layer.

A video is reproduced by combining the decoded chrominance image block with the luminance image block of the lower layer and outputting it to a display output buffer at step S514.

Meanwhile, the image block having the chrominance image block of the enhancement layer and the luminance image block of the lower layer may be stored in the reference frame at step s514.

### 4^{th} Embodiment: Color Video Scalability Decoding Device

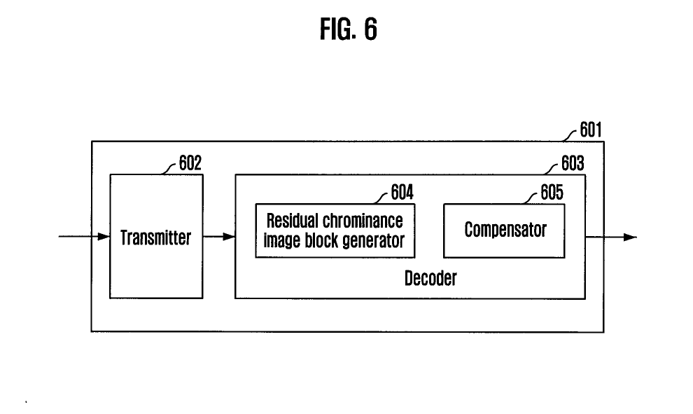

FIG. 6 is a block diagram illustrating a color video scalability decoding device in accordance with an embodiment of the present invention.

Referring to FIG. 6, the color video scalability decoding device 601 according to the present embodiment includes a receiver for receiving a bitstream and a decoder 603 for determining whether the received bitstream includes an enhancement layer having a color format different from a color format of a lower or not and decoding a chrominance image block of the enhancement layer by using lower layer information.

Here, the lower layer information may be motion information of a luminance image block of the lower layer. In this case, the decoder 603 includes a residual chrominance image block generator 604 for generating a residual chrominance image block having ‘0’s for all coefficients if the color coded block pattern is ‘0’, and generating a residual chrominance image block by entropy-encoding and inverse-quantizing information on the encoded residual chrominance image block included in the bitstream if the color code block patter is not ‘0’, and a compensator 605 for generating a chrominance image block of the enhancement layer by compensating motions of the residual chrominance image block using the motion information of the luminance image block and a reference image and combining the chrominance image block of the enhancement layer and the luminance image block of the lower layer.

Here, the lower layer information may be motion information of the chrominance image block of the lower layer. In this case, the decoder 603 includes a residual chrominance image block generator 604 for generating a residual chrominance image block having ‘0’s for all coefficients if the color coded block pattern is ‘0’, and generating a residual chrominance image block by entropy-encoding and inverse-quantizing information on the encoded residual chrominance image block included in the bitstream if the color code block patter is not ‘0’, and a compensator 605 for generating a chrominance image block of the enhancement layer by compensating motions of the residual chrominance image block using the motion information of the chrominance image block and a reference image and combining the chrominance image block of the enhancement layer and the luminance image block of the lower layer.

Since the operations of the decoder 603 and the receiver 602 of the color video scalability decoding device 601 were already described in the color video scalability decoding method according to the third embodiment, detail description thereof is omitted.

### 5^{th} Embodiment: Color Video Scalability Decoding Method

The color video scalability decoding method according to another embodiment of the present invention includes decoding a chrominance image block of an enhancement layer by using lower layer information included in a received bitstream. In the decoding a chrominance image block, determining decoding is performed or not according to a color coded block pattern value generated using the lower layer information. Therefore, it is possible to prevent repeatedly decoding the lower layer and the enhancement layer. The color video scalability decoding method may further include determining whether a color format of the enhancement layer is different from a color format of the lower layer.

The lower layer information may be motion information of a luminance image block of the lower layer. If the lower layer information is motion information of a luminance image block of the lower layer, the decoding a chrominance image block may include generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, generating a chrominance image block of the enhancement layer by compensating motion of the residual chrominance image block using the motion information and a reference image, and combining a chrominance image block of the enhancement layer and a luminance image block of the lower layer.

The lower layer information may be motion information of a chrominance image block of the lower layer. If the lower layer information is motion information of a chrominance image block of the lower layer, the decoding a chrominance image block may include generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, generating a chrominance image block of the enhancement layer by compensating motion of the residual chrominance image block using the motion information and a reference image, and combining a chrominance image block of the enhancement layer and a luminance image block of the lower layer. Since the color video scalability encoding method was described in detail in the previous embodiment, detailed description on it will not be provided herein.

### 6^{th} Embodiment: Color Video Scalability Decoding Device

The color video scalability decoding device according to another embodiment of the present invention includes a receiver for receiving a bitstream, and a decoder for encoding a chrominance image block of an enhancement layer by using lower layer information included in the received bitstream. The decoder determines whether decoding is performed according to a color coded block pattern value generated using the lower layer information. Therefore, it is possible to prevent repeatedly decoding the lower layer and the enhancement layer. Here, the decoder may determine whether a color format of the enhancement layer is different from a color format of the lower layer.

The lower layer information may be motion information of a luminance image block of the lower layer. The decoder may include a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, and a compensator for generating a chrominance image block of the enhancement layer by compensating motion of the residual chrominance image block using the motion information and a reference image, and combining a chrominance image block of the enhancement layer and a luminance image block of the lower layer.

The lower layer information may be motion information of a chrominance image block of the lower layer. The decoder may include a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, and a compensator for generating a chrominance image block of the enhancement layer by compensating motion of the residual chrominance image block using the motion information and a reference image, and combining a chrominance image block of the enhancement layer and a luminance image block of the lower layer.

Since the color video scalability encoding method was described in detail in the previous embodiment, detailed description on it will not be provided herein.

### 7^{th} Embodiment: Computer-Readable Recording Medium Storing a Program for Performing a Color Video Scalability Encoding Method

The computer-readable recording medium storing a program for performing a color video scalability encoding method includes encoding a chrominance image block of an enhancement layer by using lower layer information. In the encoding a chrominance image block, a color coded block pattern value is generated according to a pattern of quantization coefficients of a residual chrominance image block generated using the lower layer information. The color video scalability encoding method may further include determining whether a color format of the enhancement layer is different from a color format of the lower layer or not.

The lower layer information may be motion information of a luminance image block of the lower layer. If the lower layer information may be motion information of a luminance image block of the lower layer, the encoding a chrominance image block may include generating the residual chrominance image block using the motion information and a reference image, quantizing the residual chrominance image block, setting up the color coded block pattern value to ‘0’ if all coefficients of the quantized residual chrominance image block are ‘0’ and performing an entropy decoding operation on the quantized residual chrominance image block if all coefficients of the quantized residual chrominance image block are not ‘0’, and outputting encoding information of the color coded block pattern and information on the encoded residual chrominance image block as a bitstream.

The lower layer information may be motion information of a chrominance image block of the lower layer. If the lower layer information is motion information of a chrominance image block of the lower layer, the encoding a chrominance image block may include generating the residual chrominance image block using the motion information and a reference image, quantizing the residual chrominance image block, setting up the color coded block pattern value to ‘0’ if all coefficients of the quantized residual chrominance image block are ‘0’ and performing an entropy decoding operation on the quantized residual chrominance image block if all coefficients of the quantized residual chrominance image block are not ‘0’, and outputting encoding information of the color coded block pattern and information on the encoded residual chrominance image block as a bitstream.

Since the color video scalability encoding method was described in detail, the detail description thereof is omitted.

### 8^{th} Embodiment: Computer-Readable Recording Medium Storing a Program for Performing a Color Video Scalability Decoding Method

The computer-readable recording medium storing a program for performing a color video scalability decoding method includes determining whether a received bitstream includes an enhancement layer having a color format different from a color format of a lower layer, and decoding a chrominance image block of the enhancement layer by using lower layer information of the lower layer.

The lower layer information may be motion information of a luminance image block of the lower layer. The decoder may include a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, and a compensator for generating a chrominance image block of the enhancement layer by compensating motion of the residual chrominance image block using the motion information and a reference image, and combining a chrominance image block of the enhancement layer and a luminance image block of the lower layer.

The lower layer information may be motion information of a chrominance image block of the lower layer. The decoder may include a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, and a compensator for generating a chrominance image block of the enhancement layer by compensating motion of the residual chrominance image block using the motion information and a reference image, and combining a chrominance image block of the enhancement layer and a luminance image block of the lower layer.

Since the color video scalability decoding method was described in detail, the detail description thereof is omitted.

### 9^{th} Embodiment: Computer-Readable Recording Medium Storing a Program for Performing a Color Video Scalability Decoding Method

The computer-readable recording medium storing a program for performing a color video scalability decoding method includes decoding a chrominance image block of an enhancement layer by using lower layer information included in a received bitstream. In the decoding a chrominance image block, determining decoding is performed or not according to a color coded block pattern value generated using the lower layer information. The color video scalability decoding method further includes determining whether a color format of the enhancement layer is different from a color format of the lower layer.

The lower layer information may be motion information of a luminance image block of the lower layer. The decoder may include a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, and a compensator for generating a chrominance image block of the enhancement layer by compensating motion of the residual chrominance image block using the motion information and a reference image, and combining a chrominance image block of the enhancement layer and a luminance image block of the lower layer.

The lower layer information may be motion information of a chrominance image block of the lower layer. The decoder may include a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’, and a compensator for generating a chrominance image block of the enhancement layer by compensating motion of the residual chrominance image block using the motion information and a reference image, and combining a chrominance image block of the enhancement layer and a luminance image block of the lower layer.

Since the color video scalability decoding method was described in detail, the detail description thereof is omitted.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

The present invention can be applied to an encoding and decoding method and device for encoding and decoding color images having a plurality of layers having different color formats.

What is claimed is:

1. A color video scalability encoding method, comprising:
encoding a chrominance image block of an enhancement layer by using lower layer information,
wherein in said encoding a chrominance image block, a color coded block pattern value is generated according to a pattern of quantization coefficients of a residual chrominance image block generated using the lower layer information.

2. The color video scalability encoding method of claim 1, further comprising:
determining whether a color format of the enhancement layer is different from a color format of the lower layer or not.

3. The color video scalability encoding method of claim 2, wherein the lower layer information is motion information of a luminance image block of the lower layer.

4. The color video scalability encoding method of claim 3, wherein said encoding a chrominance image block includes:
generating the residual chrominance image block using the motion information and a reference image;
quantizing the residual chrominance image block;
setting up the color coded block pattern value to ‘0’ if all coefficients of the quantized residual chrominance image block are ‘0’ and performing an entropy encoding operation on the quantized residual chrominance image block if all coefficients of the quantized residual chrominance image block are not ‘0’; and
outputting encoding information of the color coded block pattern and information on the encoded residual chrominance image block as a bitstream.

5. The color video scalability encoding method of claim 2, wherein the lower layer information is motion information of a chrominance image block of the lower layer.

6. The color video scalability encoding method of claim 5, wherein said encoding a chrominance image block includes:
generating the residual chrominance image block using the motion information and a reference image;
quantizing the residual chrominance image block;
setting up the color coded block pattern value to ‘0’ if all coefficients of the quantized residual chrominance image block are ‘0’ and performing an entropy encoding operation on the quantized residual chrominance image block if all coefficients of the quantized residual chrominance image block are not ‘0’; and
outputting encoding information of the color coded block pattern and information on the encoded residual chrominance image block as a bitstream.

7. A color video scalability encoding device comprising:
an encoder for encoding a chrominance image block of an enhancement layer by using lower layer information; and
a transmitter for transmitting the encoded chrominance image block,
wherein the encoder generates a color coded block pattern value according to a pattern of quantization coefficients of a residual chrominance image block generated using the lower layer information.

8. The color video scalability encoding device of claim 7, wherein the encoder determines whether a color format of the enhancement layer is different from a color format of the lower layer or not.

9. The color video scalability encoding device of claim 8, wherein the lower layer information is motion information of a luminance image block of the lower layer.

10. The color video scalability encoding device of claim 9, wherein the encoder includes:
a quantizer for generating the residual chrominance image block using the motion information and a reference image and quantizing the residual chrominance image block; and
an entropy encoder for setting up the color coded block pattern value to ‘0’ if all coefficients of the quantized residual chrominance image block are ‘0’ and performing an entropy encoding operation on the quantized residual chrominance image block if all coefficients of the quantized residual chrominance image block are not ‘0’,
wherein an output unit outputs encoding information of the color coded block pattern and information on the encoded residual chrominance image block as a bitstream.

11. The color video scalability encoding device of claim 8, wherein the lower layer information is motion information of a chrominance image block of the lower layer.

12. The color video scalability encoding device of claim 11, wherein the encoder includes:
a quantizer for generating the residual chrominance image block using the motion information and a reference image and quantizing the residual chrominance image block; and
an entropy encoder for setting up the color coded block pattern value to ‘0’ if all coefficients of the quantized residual chrominance image block are ‘0’ and performing an entropy encoding operation on the quantized residual chrominance image block if all coefficients of the quantized residual chrominance image block are not ‘0’,
wherein an output unit outputs encoding information of the color coded block pattern and information on the encoded residual chrominance image block as a bitstream.

13. A color video scalability decoding method, comprising:
determining whether a received bitstream includes an enhancement layer having a color format different from a color format of a lower layer; and
decoding a chrominance image block of the enhancement layer by using lower layer information of the lower layer.

14. The color video scalability decoding method of claim 13, wherein the lower layer information is motion information of a luminance image block of the lower layer.

15. The color video scalability decoding method of claim 14, wherein said decoding a chrominance image block includes:
generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’;
generating a chrominance image block of the enhancement layer by compensating motion of the residual chrominance image block using the motion information and a reference image; and
combining a chrominance image block of the enhancement layer and a luminance image block of the lower layer.

16. The color video scalability decoding method of claim 13, wherein the lower layer information is motion information of a chrominance image block of the lower layer.

17. The color video scalability decoding method of claim 16, wherein said decoding a chrominance image block includes:
generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’;
generating a chrominance image block of the enhancement layer by compensating motion of the residual chrominance image block using the motion information and a reference image; and
combining a chrominance image block of the enhancement layer and a luminance image block of the lower layer.

18. A color video scalability decoding device comprising:
a receiver for receiving a bitstream; and
a decoder for determining whether the received bitstream includes an enhancement layer having a color format different from a color format of a lower layer and decoding a chrominance image block of the enhancement layer by using lower layer information of the lower layer.

19. The color video scalability decoding device of claim 18, wherein the lower layer information is motion information of a luminance image block of the lower layer.

20. The color video scalability decoding device of claim 19, wherein the decoder includes:
a residual chrominance image block generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’; and
a compensator for generating a chrominance image block of the enhancement layer by compensating motion of the residual chrominance image block using the motion information and a reference image, and combining a chrominance image block of the enhancement layer and a luminance image block of the lower layer.

21. The color video scalability decoding device of claim 18, wherein the lower layer information is motion information of a chrominance image block of the lower layer.

22. The color video scalability decoding device of claim 21, wherein the decoder includes:
a residual chrominance image block generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’; and
a compensator for generating a chrominance image block of the enhancement layer by compensating motion of the residual chrominance image block using the motion information and a reference image, and combining a chrominance image block of the enhancement layer and a luminance image block of the lower layer.

23. A color video scalability decoding method comprising:
decoding a chrominance image block of an enhancement layer by using lower layer information included in a received bitstream,
wherein in said decoding a chrominance image block, whether decoding is performed or not is determined according to a color coded block pattern value generated using the lower layer information.

24. The color video scalability decoding method of claim 23, further comprising:
determining whether a color format of the enhancement layer is different from a color format of the lower layer.

25. The color video scalability decoding method of claim 13, wherein the lower layer information is motion information of a luminance image block of the lower layer.

26. The color video scalability decoding method of claim 14, wherein said decoding a chrominance image block includes:
generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’;
generating a chrominance image block of the enhancement layer by compensating motion of the residual chrominance image block using the motion information and a reference image; and
combining a chrominance image block of the enhancement layer and a luminance image block of the lower layer.

27. The color video scalability decoding method of claim 13, wherein the lower layer information is motion information of a chrominance image block of the lower layer.

28. The color video scalability decoding method of claim 16, wherein said decoding a chrominance image block includes:
generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’;
generating a chrominance image block of the enhancement layer by compensating motion of the residual chrominance image block using the motion information and a reference image; and
combining a chrominance image block of the enhancement layer and a luminance image block of the lower layer.

29. A color video scalability decoding device comprising:
a receiver for receiving a bitstream; and
a decoder for encoding a chrominance image block of an enhancement layer by using lower layer information included in the received bitstream,
wherein the decoder determines whether decoding is performed according to a color coded block pattern value generated using the lower layer information.

30. The color video scalability decoding method of claim 29, wherein the decoder determines whether a color format of the enhancement layer is different from a color format of the lower layer.

31. The color video scalability decoding device of claim 30, wherein the lower layer information is motion information of a luminance image block of the lower layer.

32. The color video scalability decoding device of claim 31, wherein the decoder includes:
a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’; and
a compensator for generating a chrominance image block of the enhancement layer by compensating motion of the chrominance image block using the motion information and a reference image, and combining a chrominance image block of the enhancement layer and a luminance image block of the lower layer.

33. The color video scalability decoding device of claim 30, wherein the lower layer information is motion information of a chrominance image block of the lower layer.

34. The color video scalability decoding device of claim 33, wherein the decoder includes: a residual chrominance image generator for generating a residual chrominance image block having ‘0’ for all coefficients if a color coded block pattern value is ‘0’, and generating a residual chrominance image block by performing entropy decoding and inverse quantization on information of an encoded residual chrominance image bock included in the bitstream if the color coded block pattern value is not ‘0’; and
a compensator for generating a chrominance image block of the enhancement layer by compensating motion of the residual chrominance image block using the motion information and a reference image, and combining a chrominance image block of the enhancement layer and a luminance image block of the lower layer.

35. A computer-readable recording medium storing a program for performing a color video scalability encoding method comprising:
encoding a chrominance image block of an enhancement layer by using lower layer information,
wherein in said encoding a chrominance image block, a color coded block pattern value is generated according to a pattern of quantization coefficients of a residual chrominance image block generated using the lower layer information.

36. A computer-readable recording medium storing a program for performing a color video scalability decoding method comprising:
determining whether a received bitstream includes an enhancement layer having a color format different from a color format of a lower layer; and
decoding a chrominance image block of the enhancement layer by using lower layer information of the lower layer.

37. A computer-readable recording medium storing a program for performing a color video scalability decoding method comprising:
decoding a chrominance image block of an enhancement layer by using lower layer information included in a received bitstream,
wherein in said decoding a chrominance image block, determining decoding is performed or not according to a color coded block pattern value generated using the lower layer information.
